(19) United States
(12) Patent Application Publication
(10) Pub. No.: US 2012/0106896 A1
(43) Pub. Date: May 3, 2012

(54) CABLE ASSEMBLY FOR OPTICAL TERMINATION

(75) Inventors: HSIEN-CHU LIN, New Taipei (TW); HSIANG-CHI WEN, New Taipei (TW)

(73) Assignee: HON HAI PRECISION INDUSTRY CO., LTD., New Taipei (TW)

(21) Appl. No.: 13/284,950

(22) Filed: Oct. 30, 2011

(30) Foreign Application Priority Data
Oct. 29, 2010 (TW) 099220891

(51) Int. Cl. G02B 6/36

(52) U.S. Cl. 385/76

(57) ABSTRACT

A cable assembly (100) includes a lens (1) defining a mounting hole (12), the mounting hole having at least three inner sides connected with each other; a fiber (3) cable having a core portion (31) and a shielding portion (32) enclosing the core portion, the core portion inserted into the mounting hole of the lens and substantially contacting with all of the inner sides thereof; and optical glue (4) applied to the mounting hole and filling grooves between the inner sides and a peripheral of the core portion of the fiber.

### FIELD OF THE INVENTION

The present invention generally relates to a cable assembly, and more particularly to a cable assembly adapted for optical transmitting.

### DESCRIPTION OF PRIOR ART

In many of today's processing systems, such as personal computer (PC) systems, there exist universal serial bus (USB) ports for connecting various USB devices. Different standards of USB technology for different bandwidths have been launched by USB-IF supported by some of world largest IT companies. For instance, Universal Serial Bus Specification, revision 1.1 devices are capable of operating at 12 Mbits/second(Mbps). Universal Serial Bus Specification, revision 2.0 devices are capable of operating at 480 Mbps. Universal Serial Bus Specification, revision 3.0 devices are capable of operating at higher speed also accepted by market, gradually. However, as technology progresses engineers are constantly striving to increase operating speeds.

For example, CN Pub. Pat. No. 101345358 published on Jan. 14, 2009 discloses an optical USB connector assembly which has a fiber device added to a USB connector assembly. The fiber device has a number of fibers connected with lenses embedded in the USB connector. Thus, optical signal transmits along a first fiber and is expanded/magnified by a first lens terminated to the first fiber, and then shrunk by a second lens and runs through second fiber of a complementary connector. The fiber needs to be inserted into a mounting hole of the lens so as to achieve better optical coupling therebetween. However, there exists gap between the fiber and the mounting hole of the lens, resulting in optical transmitting loss and further effect signal transmitting. In addition, as the fiber and lens are in relative lose state, also effect signal transmitting.

Hence, an improved cable assembly is highly desired to overcome the aforementioned problems.

### SUMMARY OF THE INVENTION

Accordingly, an object of the present invention is to provide a cable assembly reliably transmitting optical signal.

In order to achieve the object set forth, a cable assembly in accordance with the present invention comprises a lens defining a mounting hole, the mounting hole having at least three inner sides connected with each other; a fiber cable having a core portion and a shielding portion enclosing the core portion, the core portion inserted into the mounting hole of the lens and substantially contacting with all of the inner sides thereof; and optical glue applied to the mounting hole and filling grooves between the inner sides and a peripheral of the core portion of the fiber.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of a cable assembly of the first embodiment in accordance with the present invention;

FIG. 2 is similar to FIG. 1, but viewed from other aspect;

FIG. 3 is an exploded, perspective view of FIG. 2;

FIG. 4 is a cross-section view of FIG. 1 taken along line 4-4;

FIG. 5 is a cross-section view of FIG. 1 taken along line 5-5;

FIG. 6 is a partially enlarged view of FIG. 5;

FIG. 7 is an assembled, perspective view of the cable assembly of the second embodiment in accordance with the present invention;

FIG. 8 is a cross-section view of FIG. 7 taken along line 8-8; and

FIG. 9 is a partial enlarged view of FIG. 8.

### DETAILED DESCRIPTION OF PREFERRED EMBODIMENTS

Reference will now be made in detail to the preferred embodiment of the present invention.

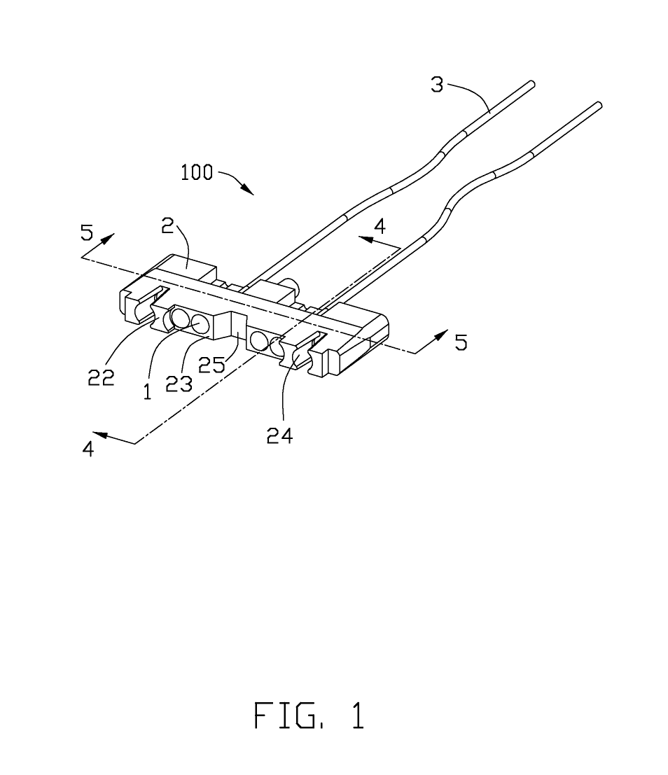

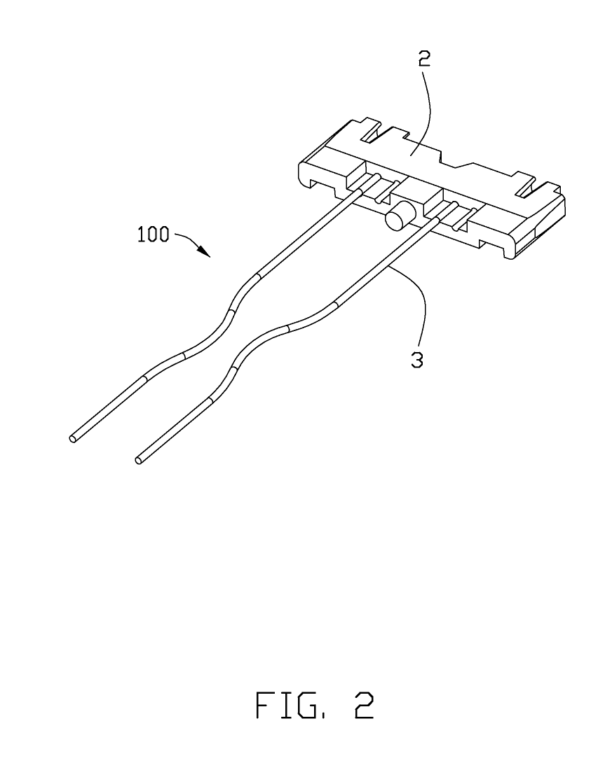

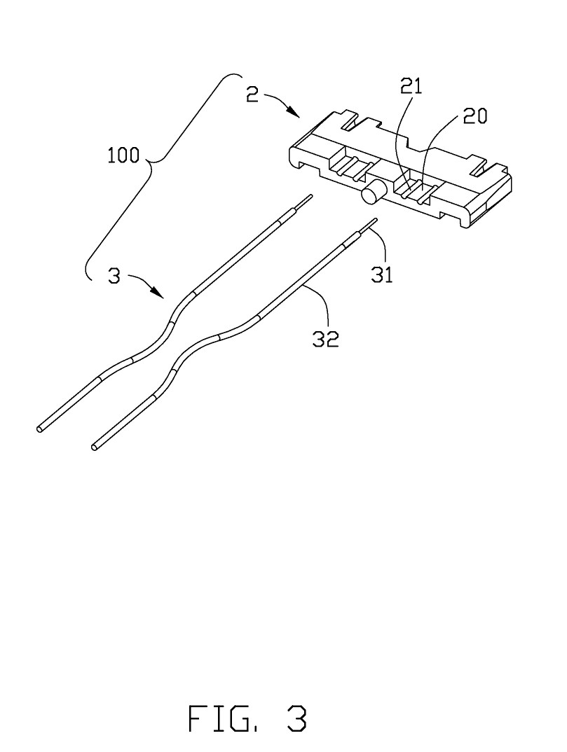

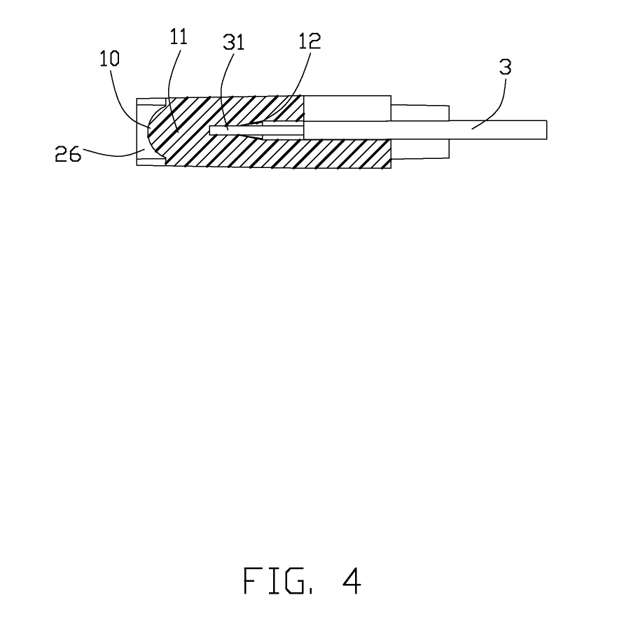

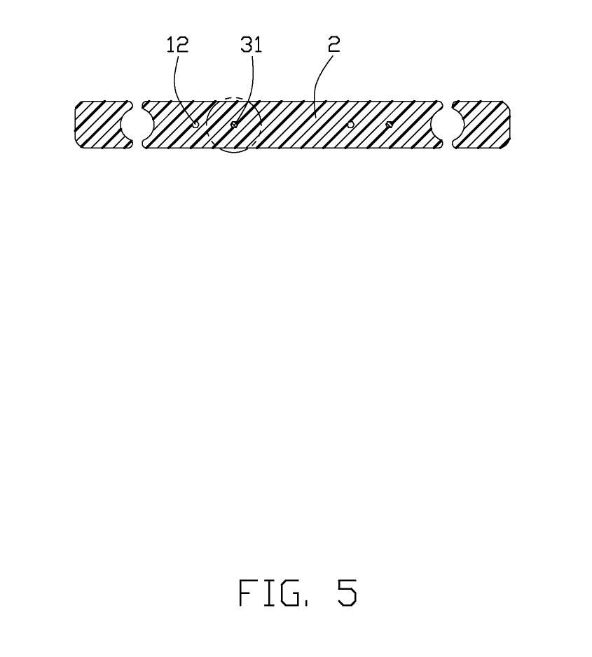

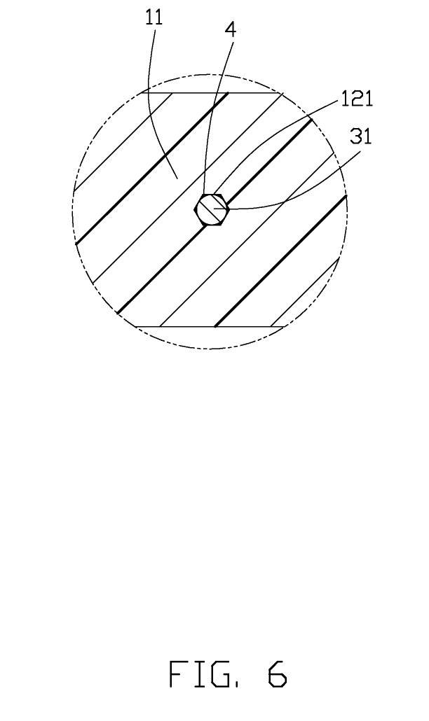

Referring to FIGS. 1-6, a cable assembly 100 of the first embodiment in accordance with the present invention comprises a number of lenses 1 arranged in a row along a transversal direction, a housing 2 enclosing the lenses 1 and a number of fiber cables 3 connected to the lenses 1, respectively.

Each lens 1 has a cylindrical shaped body portion 11. There is a mounting hole 12 defined in a central of the body portion 11 and the mounting hole 12 is a blind hole with a predetermined depth recessed forwardly from a back edge of the body portion 11. The mounting hole 12 is hexagonal shape which has six regular inner sides 121 connected with each other. The mounting hole 12 has a back segment larger than a front segment thereof In addition, there is a tapered transition segment between a back segment and a front segment of the mounting hole 12.

The housing 2 has an elongated main portion. The lenses 2 are arranged in at least one row along the transversal direction and embedded in the housing 2. The lenses 2 are separated from each other along the transversal direction. There are two cavities 20 defined in a back segment of the housing 2. The two cavities 20 are arranged in juxtaposed manner. Each cavity 20 is opened upwardly. There are two positioning grooves 21 defined in a bottom side of each cavity 20. Each positioning groove 21 aligns with a corresponding mounting hole 12 along a front-to-back direction. There are two guiding holes 24 recessed backwardly from lateral sections 22 of a front portion of the housing 2. There is a depression area 26 located in a middle section 23 of the front portion of the housing 2. In addition, there is an alignment cavity 25 located in a center of the depression area 26. The alignment cavity 25 has a broader front opening The lenses 2 are symmetrically arranged with regarding to the alignment cavity 25 and forwardly protrude into the depression area 26.

Each fiber cable 3 has a core portion 31 and a shielding portion 32 enclosing the core portion 31.

Partial of a front segment of the shielding portion 32 is stripped off to expose the core portion 31 exposed outside. The fiber cable 3 is optically coupled to the lens 1. The core portion 31 is inserted into the mounting hole 12 of the lens 1, with a peripheral of the core portion 31 contacting with all the inner sides 121, so as to prohibit the core portion 31 moving excessively along a radial direction. In this embodiment, as the core portion 31 is circular shape, and the core portion 31 circumferentially contacts with middle sections of the inner sides 121, and forming a longitudinal slot (not numbered) between every two adjacent inner sides 121 and the peripheral of the core portion 31. By such arrangement, the core portion 31 is securely and precisely positioned in the mounting hole 12. The shielding portion 32 of the corresponding fiber cable 3 is received in the positioning groove 21.

Optical glue 4 is applied to the mounting hole 12 and fills into longitudinal slots so as to combine the core portion 31 and the corresponding lens 1 together.

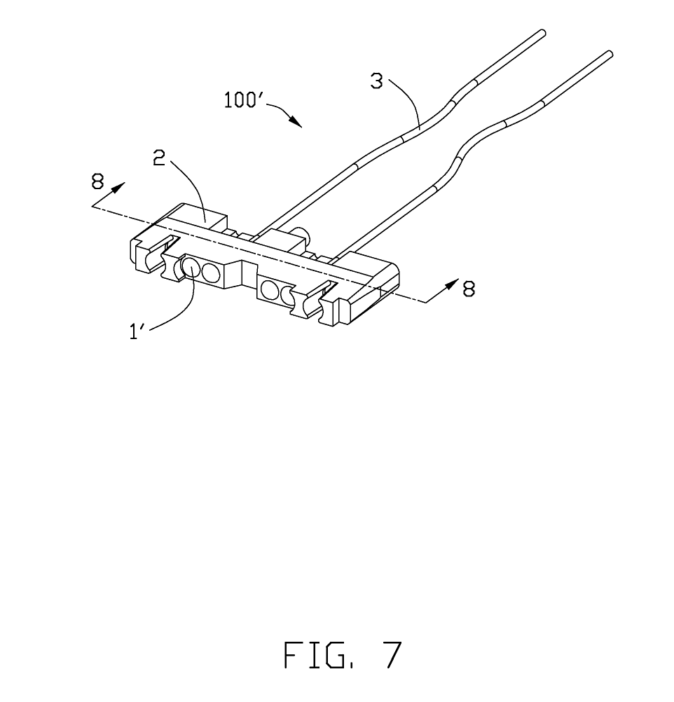

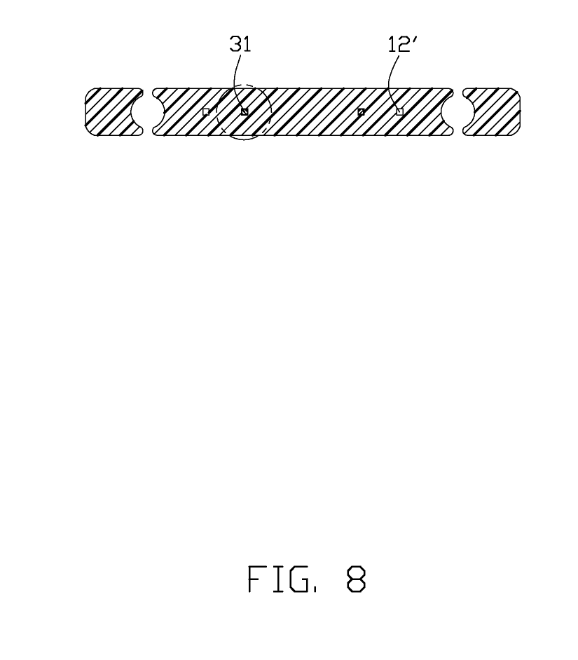

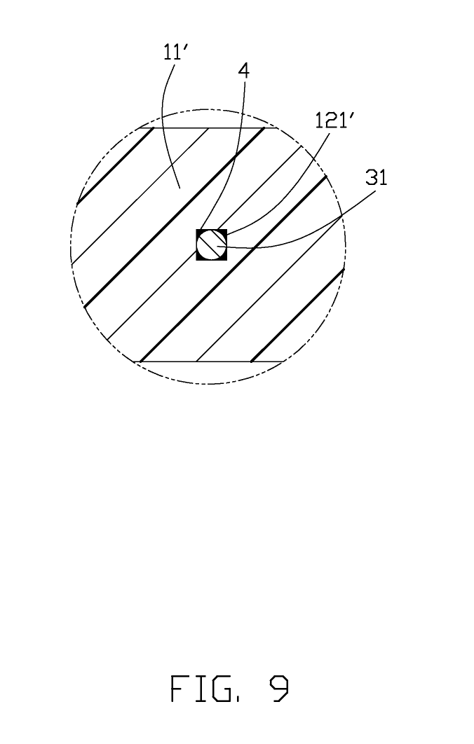

Referring to FIGS. 7-9 and in conjunction with FIGS. 1-6, a cable assembly 100′ of a second embodiment of the present invention is similar to the cable assembly 100 of the first embodiment, except that lenses 1′ of the cable assembly 100′, and other same elements and relations therebetween are omitted hereby.

Each lens 1′ has a cylindrical shaped body portion. There is a mounting hole 12′ defined in a central of the body portion and the mounting hole 12′ is a blind hole with a predetermined depth recessed forwardly from a back edge of the body portion. The mounting hole 12′ is rectangular shape which has four equal inner sides 121′ connected with each other.

The core portion 31 is inserted into the mounting hole 12′ of the lens 1′, with the peripheral of the core portion 31 contacting with four inner sides 121′. In this embodiment, the core portion 31 circumferentially contacts with middle sections of the inner sides 121′, and forming four longitudinal slot (not numbered) between inner sides 121′ and the peripheral the core portion 31. By such arrangement, the core portion 31 is securely and precisely positioned in the mounting hole 12′. Optical glue 4 is applied to the mounting hole 12′ and fills into longitudinal slots so as to combine the core portion 31 and the corresponding lens 1′ together.

The mounting hole of the lens may be triangular shape or other regular polygonal shape in alternative embodiment.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A cable assembly, comprising:
a lens defining a mounting hole, the mounting hole having at least three inner sides connected with each other;
a fiber cable having a core portion and a shielding portion enclosing the core portion, the core portion inserted into the mounting hole of the lens and substantially contacting with all of the inner sides thereof; and
optical glue applied to the mounting hole and filling grooves between the inner sides and a peripheral of the core portion of the fiber.

2. The cable assembly as recited in claim 1, wherein the mounting hole is a blind hole.

3. The connector assembly as recited in claim 1, wherein the mounting hole is hexagonal shape with six regular inner sides connected with each other.

4. The connector assembly as recited in claim 1, wherein the mounting hole is rectangular shape with four equal inner sides connected with each other.

5. A cable assembly, comprising:
a housing defining an elongated main portion;
a plurality of lenses separated from each other and embedded in the main portion of the housing, each of the lenses defining a mounting hole, the mounting hole having at least three inner sides connected with each other;
a corresponding fiber for optically coupling with each lens, the fiber cable having a core portion and a shielding portion enclosing the core portion, the core portion inserted into the mounting hole of the lens and substantially contacting with the inner sides thereof, under the condition that the core portion is prohibited to excessively move along radial directions, but form at least one longitudinal slot between two of the adjacent inner sides and a peripheral of the core portion for accommodating optical glue therein.

6. The cable assembly as recited in claim 5, wherein the mounting hole is hexagonal shape with six regular inner sides connected with each other, and the core portion contacts middle sections of the inner sides.

7. The cable assembly as recited in claim 5, wherein the mounting hole is rectangular shape with four equal inner sides connected with each other, and the core portion contacts middle sections of the inner sides.

8. The cable assembly as recited in claim 5, wherein there is a cavity defined in a back segment of the housing, and the cavity is opened upwardly.

9. The cable assembly as recited in claim 8, wherein there is at least one positioning groove defined in a bottom side of the cavity and aligning with the mounting hole of the corresponding lens along a front to back direction.

10. The cable assembly as recited in claim 9, wherein the shielding portion of the corresponding fiber cable is received in the positioning groove.

11. The cable assembly as recited in claim 5, wherein there are two guiding holes recessed backwardly from lateral sections of a front portion of the housing.

12. The cable assembly as recited in claim 5, wherein there is a depression area located a middle section of the front portion of the housing, and the lenses protrude into the depression area.

13. The cable assembly as recited in claim 12, wherein there is an alignment cavity located in a center of the depression area.

14. The cable assembly as recited in claim 13, wherein the alignment cavity has a broader front opening.

15. The cable assembly as recited in claim 13, wherein the lenses are symmetrically arranged with regarding to the alignment cavity.

16. A cable assembly comprising:
a lens defining a front bulged interface and a rear mounting hole in alignment with the bulged interface;
a round core of an optic fiber forwardly inserted into the mounting hole from a rear side of the lens; wherein
a front end region of the mounting hole defines a polygonal interior face so as to form a gap with regard to the round core.

17. The cable assembly as claimed in claim 16, wherein said polygonal interface is essentially symmetric with regard to a center thereof.

18. The cable assembly as claimed in claim 17, wherein said mounting hole further defines an outward tapered structure behind the front end region for easy insertion of the core of the optic fiber.

19. The cable assembly as claimed in claim 18, wherein the lens further defines a groove behind the mounting hole to snugly receive the optic fiber.

20. The cable assembly as claimed in claim 19, wherein said groove is open to an exterior in a vertical direction perpendicular to an axial direction of the mounting hole.
